(19) United States
(12) Patent Application Publication
(10) Pub. No.: US 2009/0280665 A1
(43) Pub. Date: Nov. 12, 2009

(54) ELECTRONIC DEVICE HAVING ROTATABLE PLUG

(75) Inventor: Ming-Tang Yang, Taoyuan Hsien (TW)

Correspondence Address: KIRTON AND MCCONKIE, 60 EAST SOUTH TEMPLE,, SUITE 1800, SALT LAKE CITY, UT, 84111, US

(73) Assignee: DELTA ELECTRONICS, INC., Taoyuan Hsien (TW)

(21) Appl. No.: 12/335,034

(22) Filed: Dec. 15, 2008

(30) Foreign Application Priority Data
May 9, 2008 (TW) 097117253

(51) Int. Cl. H01R 29/00

(52) U.S. Cl. 439/173

(57) ABSTRACT

The present invention provides an electronic device having a rotatable plug. The electronic device includes a casing having a hollow portion, a rotary base rotatably mounted within the casing, and a circuit board mounted within the casing. The rotary base includes a rotating disc and a plug. The plug includes conducting pins. The conducting pins are coupled with the rotating disc such that respective first ends of the conducting pins are exposed and protruded through the hollow portion of the casing and respective second ends of the conducting pins are protruded from bilateral sides of the rotating disc. The circuit board includes a first conductive element and a second conductive element corresponding to the first and second conducting pins. The first conducting pin and the second conducting pin are electrically connected to the circuit board when the rotary base is rotated to a specified position.

### FIELD OF THE INVENTION

The present invention relates to an electronic device having a plug, and more particularly to an electronic device having a rotatable plug.

### BACKGROUND OF THE INVENTION

Power converters such as power adapters or chargers become indispensable electronic devices for many kinds of electrical apparatuses. For example, by means of the power adapters, the utility power may be rectified and then converted into DC power for supplying power-receiving devices such as notebook computers. Alternatively, by means of the chargers, the converted DC power may be charged into the rechargeable batteries of the power-receiving devices such as mobile phones or digital cameras.

A power converter principally includes a casing, a plug and a circuit board mounted within the casing.

Referring to FIG. 1, a schematic perspective view of a conventional power adapter is illustrated. The power adapter 1 of FIG. 1 includes a casing 11, a plug 12 and a circuit board (not shown) inside the casing 11. Conventionally, the plug 12 of a power adapter comprises two conducting pins, which are projected from one side of the casing 11. The arrangement of the circuit board is dependent on the function of the power converter, for example being as an adapter or a charger, to perform rectification or conversion for a power-receiving device. Via the plug, external utility power is transmitted to the circuit board.

Since the plug 12 of the conventional power adapter 1 is unable to be rotated, some drawbacks occur. For example, the plug 12 needs to accommodate itself to the orientations of the slots of the wall power socket in order for achieving the electrical connection. After the plug 12 of the power adapter 1 is inserted into a power socket, the volume of the power adapter 1 becomes hindrance from inserting the plug of other electronic device into adjacent wall power socket. Moreover, if the power socket is located at the wall corner or other articles are disposed in the vicinity of the power socket, the space utilization of the power socket is restricted. Under this circumstance, it is difficult to insert the plug into the power socket.

Therefore, there is a need of providing an electronic device having a rotatable plug to obviate the drawbacks encountered from the prior art.

### SUMMARY OF THE INVENTION

It is an object of the present invention to provide an electronic device having a rotatable plug, in which the rotatable plug is easily assembled and securely fixed in one of multiple positions.

An object of the present invention provides an electronic device having a rotatable plug, in which the conducting pins of the rotatable plug are always electrically connected to the circuit board when the rotatable plug is fixed at a specified position.

In accordance with an aspect of the present invention, there is provided an electronic device having a rotatable plug. The electronic device includes a casing having a hollow portion, a rotary base rotatably mounted within the casing, and a circuit board mounted within the casing. The rotary base includes a rotating disc and a plug. The plug includes a first conducting pin and a second conducting pin. The first and second conducting pins are coupled with the rotating disc such that respective first ends of the first and second conducting pins are exposed and protruded through the hollow portion of the casing and respective second ends of the first and second conducting pins are protruded from bilateral sides of the rotating disc. The circuit board includes a first conductive element and a second conductive element corresponding to the first and second conducting pins. The first conducting pin and the second conducting pin are respectively contacted with the first conductive element and the second conductive element when the rotary base is rotated to a first position. The first conducting pin and the second conducting pin are respectively contacted with the second conductive element and the first conductive element when the rotary base is rotated to a second position.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view of a conventional power adapter;

FIG. 2 is a schematic assembled view of an electronic device having a rotatable plug according to a first preferred embodiment of the present invention;

FIG. 3 is a schematic exploded view of the electronic device shown in FIG. 2;

FIG. 4 is a schematic perspective view illustrating a rotary base of the electronic device shown in FIG. 3;

FIG. 5 is a schematic perspective view illustrating a plug included in the rotary base of FIG. 4;

FIGS. 6˜8 schematically illustrate the electronic device of the present invention, in which the rotary base is located in different positions; and

FIG. 9 is a schematic exploded view of an electronic device having a rotatable plug according to a second preferred embodiment of the present invention.

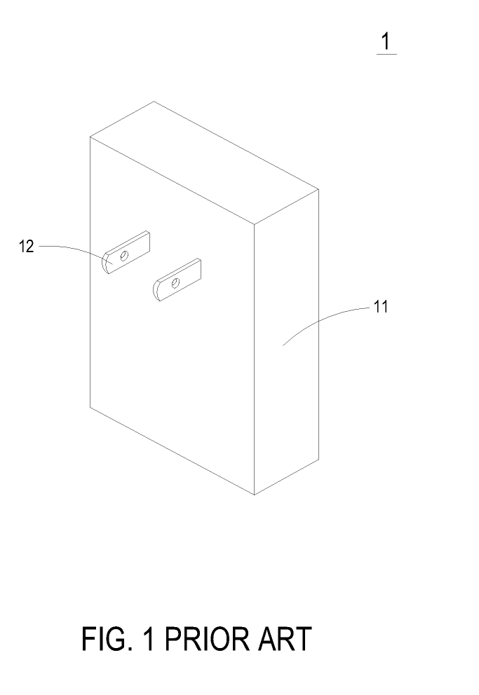

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

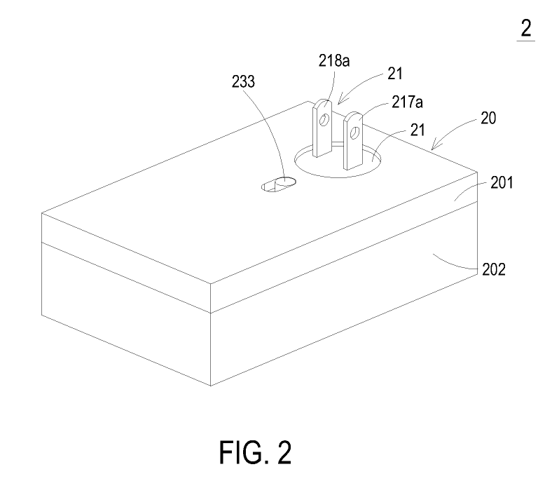

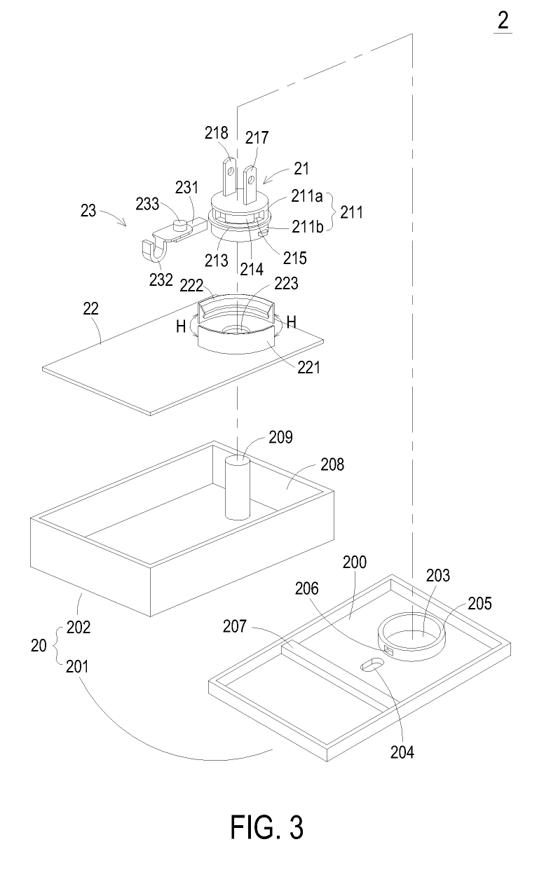

FIGS. 2 and 3 are respectively schematic assembled and exploded views of an electronic device having a rotatable plug according to a first preferred embodiment of the present invention. An example of the electronic device 2 includes but is not limited to a power converter. The electronic device 2 principally comprises a casing 20, a rotary base 21, a circuit board 22 and a retaining member 23. A receptacle inside the casing 20 may receive a portion of the rotary base 21, the circuit board 22 and the retaining member 23. The casing 20 comprises a first case element 201 and a second case element 202. In some embodiment, the first case element 201 and the second case element 202 are combined together via an ultrasonic welding technology. Alternatively, the first case element 201 and the second case element 202 are combined together by screwing or fastening means. A hollow portion 203 and a perforation 204 are formed in the first case element 201. The perforation 204 is disposed in the vicinity of the hollow portion 203. The hollow portion 203 and the perforation 204 are both extended from the internal surface to the external surface of the first case element 201.

In some embodiments, an annular frame 205 is formed on the inner surface of the first case element 201 and around the periphery of the hollow portion 203. An opening 206 is formed in the sidewall of the first case element 201 and beside the perforation 204. The rotary base 21 is received in the hollow portion 203 and enclosed by the annular frame 205. In addition, a sustaining element 207 is formed on the internal surface of the first case element 201 and extended between bilateral edges of the first case element 201. An example of the sustaining element 207 includes but is not limited to a transverse bar. The second case element 202 has a retaining post 209, which is extended from the internal surface of the second case element 202 and corresponding to the hollow portion 203 of the first case element 201.

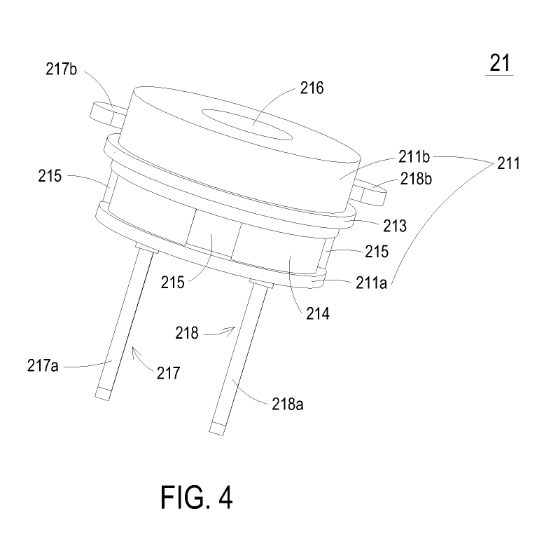

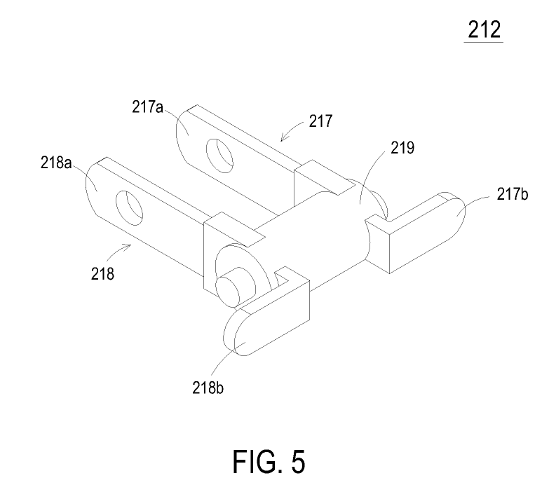

FIG. 4 is a schematic perspective view illustrating a rotary base of the electronic device shown in FIG. 3. FIG. 5 is a schematic perspective view illustrating a plug included in the rotary base of FIG. 4. Please refer to FIGS. 2˜5. The rotary base 21 is rotatably mounted within the casing 20. The rotary base 21 comprises a rotating disc 211 and a plug 212, and is formed by a metallic insert molding process. The rotating disc 211 is received in the hollow portion 203 and enclosed by the annular frame 205. The rotating disc 211 has a stopper 213 on the sidewall thereof such that the rotating disc 211 is divided into a first segment 211a and a second segment 211b by the stopper 213. The outer diameter of the stopper 213 is greater than that of the annular frame 205. When the first segment 211a of the rotating disc 211 is received in the hollow portion 203, the stopper 213 is sustained against the annular frame 205. In other words, the second segment 211b of the rotating disc 211 is stopped by the stopper 213 and fails to be received in the hollow portion 203. Under this circumstance, the rotating disc 211 is partially received in the hollow portion 203 and partially enclosed by the annular frame 205.

In some embodiments, the rotating disc 211 further comprises a guiding slot 214 and a plurality of retaining holes 215. The guiding slot 214 is formed in the external surface of the first segment 211a of the rotating disc 211 for partially receiving the retaining member 23 therein so as to confine the rotating range of the rotary base 21. The length of the guiding slot 214 is substantially equal to a half arc length of the first segment 211a of the rotating disc 211. These retaining holes 215 are discretely arranged in the guiding slot 214 at regular intervals. The location and the size of each retaining hole 215 correspond to the opening 206 of the first case element 201. For illustration, only three retaining holes 215 are shown in the drawings, in which every two adjacent retaining holes 215 are discretely arranged in the guiding slot 214 at 90 degrees with respect to the centerline of the rotating disc 211.

In some embodiments, the rotating disc 211 further comprises an indentation 216 disposed in a bottom surface of the second segment 211b of the rotating disc 211 and corresponding to the retaining post 209 of the second case element 202 (as shown in FIG. 4). The retaining post 209 of the second case element 202 is inserted into the indentation 216 so as to facilitate positioning the rotary base 21 within the casing 20.

The plug 212 comprises a first conducting pin 217, a second conducting pin 218 and a rotating shaft 219. The first conducting pin 217 and the second conducting pin 218 have first ends 217a, 218a and second ends 217b, 218b, respectively. The first ends 217a, 218a are respectively perpendicular to the second ends 217b, 218b. In some embodiments, the first conducting pin 217 and the second conducting pin 218 are coupled with the rotating shaft 219 by a plastic molding process. As such, the first ends 217a, 218a and the second ends 217b, 218b of the conducting pins 217 and 218 are respectively exposed to opposite sides of the rotating shaft 219. In some embodiments, the plug 212 and the rotating disc 211 are integrally formed as the rotary base 21. As shown in FIGS. 3 and 4, the first ends 217a, 218a of the conducting pins 217 and 218 of the plug 212 are protruded from a top surface of the first segment 211a of the rotating disc 211 while the second ends 217b, 218b of the conducting pins 217 and 218 are protruded from bilateral sides of the second segment 211b of the rotating disc 211. For assembling the rotary base 21, which is positioned within the casing 20, the first ends 217a, 218a of the conducting pins 217 and 218 are penetrated through the hollow portion 203 such that the rotating disc 211 is partially received in the hollow portion 203 and enclosed by the annular frame 205.

In some embodiment, the plug 212 and the rotating disc 211 are combined together by fastening means. Alternatively, the first conducting pin 217 and the second conducting pin 218 are integrally formed with the rotating disc 211 by metallic insert molding process, thereby forming the rotary base 21. It is noted that, however, those skilled in the art will readily observe that numerous modifications and alterations may be made while retaining the teachings of the invention. For example, the plug 212 may be made foldable if some grooves (not shown) are formed on the top surface of the first segment 211a of the rotating disc 211 and the first case element 201 and the second ends 217b, 218b of the conducting pins 217 and 218 have cylindrical shapes. Under this circumstance, the first conducting pin 217 and the second conducting pin 218 are foldable with the second ends 217b, 218b serving as pivotal shafts, thereby storing the conducting pins 217 and 218.

The retaining member 23 is interconnected between the sustaining element 207 of the first case element 201 and the rotating disc 211. The retaining member 23 comprises an alignment post 231, a resilient element 232 and a protrusion 233. The alignment post 231 is penetrated through the opening 206 of the first case element 201 and then inserted into one of the retaining holes 215 of the rotating disc 211. When the alignment post 231 is inserted into one of the retaining holes 215, the rotating disc 211 is fixed at a specified position. An example of the resilient element 232 includes a spring or an elastic hooking element. The resilient element 232 has one terminal contacted with the alignment post 231 and the other terminal contacted with or sustained against the sustaining element 207 of the first case element 201. During the process of rotating the rotating disc 211 from a first position to a second position, the alignment post 231 is gradually detached from the retaining hole 215 and sustained against the guiding slot 214 such that the resilient element 232 is compressed. Until the rotating disc 211 reaches the second position and the alignment post 231 is aligned with another retaining hole 215, the restoring force of the resilient element 232 will push forward the alignment post 231 such that the alignment post 231 is inserted to this retaining hole 215 and the rotating disc 211 is fixed at the second position. It is noted that, however, those skilled in the art will readily observe that numerous modifications and alterations may be made while retaining the teachings of the invention. For example, the sustaining element 207 may be a partition plate. In addition, the sustaining element 207 may be arranged on the circuit board 22 or the second case element 202 as long as the sustaining element 207 is sustained against the resilient element 232 of the retaining member 23.

The protrusion 233 is disposed on the resilient element 232 and received in the perforation 204 of the first case element 201. During the process of rotating the rotating disc 211 from one position to another position, the alignment post 231 is gradually detached from the retaining hole 215 and the protrusion 233 is moved toward the sustaining element 207 to compress the resilient element 232.

In some embodiments, the alignment post 231, the resilient element 232 and the protrusion 233 of the retaining member 23 are integrally formed. The diameter of the protrusion 233 is equal to or slightly smaller than the width of the perforation 204 of the first case element 201. As such, after the protrusion 233 is received in the perforation 204, the protrusion 233 is clamped by the sidewall of the perforation 204 so as to facilitate fixing the retaining member 23. In some embodiments, some partition plates (not shown) may be arranged on the circuit board 22 or the first case element 201 for facilitating fixing the retaining member 23. Alternatively, the protrusion 233 has grained or textured surface in order to increase friction.

The circuit board 22 is mounted within the casing 20 and arranged between the second case element 202 and the rotary base 21. The circuit board 22 is also coupled with the rotary base 21. The circuit board 22 has a power converting circuit (not shown). By the power converting circuit, the utility power is converted into regulated DC power. The circuit board 22 also comprises a first conductive element 221 and a second conductive element 222. The first conductive element 221 and the second conductive element 222 are for example arc-shaped conductive plates. The first conductive element 221 and the second conductive element 222 are disposed on opposite sides of the rotary base 21 and corresponding to the second ends 217b, 218b of the conducting pins 217 and 218. In a case that the second end 217b of the first conducting pin 217 is contacted with the first conductive element 221, the second end 218b of the second conducting pin 218 is contacted with the second conductive element 222. Whereas, in a case that the second end 217b of the first conducting pin 217 is contacted with the second conductive element 222, the second end 218b of the second conducting pin 218 is contacted with the first conductive element 221.

For safety, the first conductive element 221 and the second conductive element 222 are spaced from each other by a gap H (as shown in FIG. 3), thereby providing a desired creepage distance between the first conducting pin 217 and the second conducting pin 218. In some embodiments, the circuit board 22 further comprises a perforation 223 corresponding to the indentation 216 of the rotating disc 211 and the retaining post 209 of the second case element 202. The retaining post 209 is penetrated through the perforation 223 of the circuit board 22 and partially received in the indentation 216 of the rotating disc 211 such that the circuit board 22 is positioned within the casing 20 by the retaining post 209.

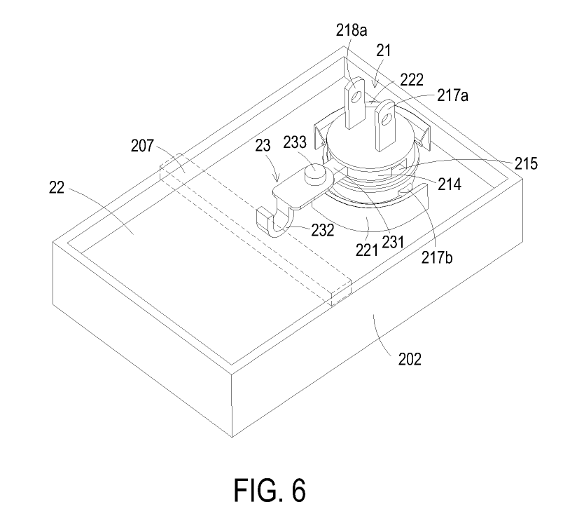

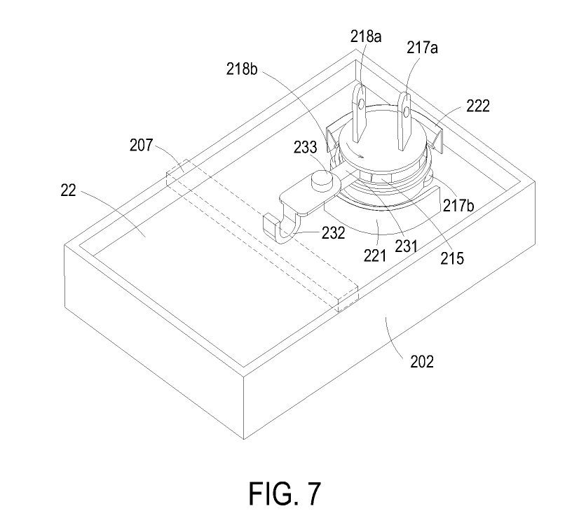

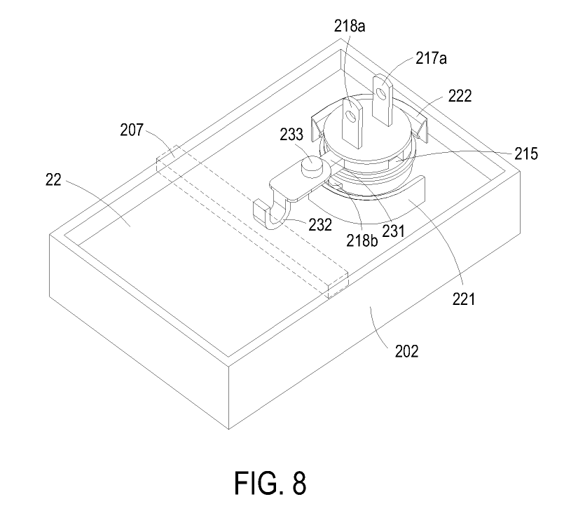

FIGS. 6˜8 schematically illustrate the electronic device of the present invention, in which the rotary base is located in different positions. Hereinafter, operations of the rotary base 21 will be illustrated as follows with reference to FIGS. 6˜8 as well as FIGS. 2˜5. In FIG. 6, the rotary base 21 is fixed in a first position while the alignment post 231 is inserted into one of the retaining holes 215. Under this circumstance, the second end 217b of the first conducting pin 217 is contacted with the first conductive element 221 and the second end 218b of the second conducting pin 218 is contacted with the second conductive element 222, so that the conducting pins 217 and 218 are electrically connected to the circuit board 22.

Next, as shown in FIG. 7, the rotary base 21 is rotated in an anticlockwise direction. During the process of rotating the rotating disc 211 from one position to another position, the alignment post 231 is gradually detached from the retaining hole 215 and the protrusion 233 is moved toward the sustaining element 207 to compress the resilient element 232. Meanwhile, conducting pins 217 and 218 are not contacted with the conductive elements 221 and 222.

Next, as shown in FIG. 8, the rotary base 21 is continuously rotated in the anticlockwise direction such that the alignment post 231 is aligned with another retaining hole 215. Due to the restoring force of the resilient element 232, the alignment post 231 is inserted to this retaining hole 215 such that the rotating disc 211 is fixed at the second position. Since every two adjacent retaining holes 215 are discretely arranged in the guiding slot 214 at 90 degrees, the rotary base 21 is rotated by 90 degrees from the first position to the second position. In other words, the conducting pins 217 and 218 are also rotated by 90 degrees. Under this circumstance, the second end 217b of the first conducting pin 217 is contacted with the second conductive element 222, the second end 218b of the second conducting pin 218 is contacted with the first conductive element 221, so that the conducting pins 217 and 218 are electrically connected to the circuit board 22.

The length of the guiding slot 214 and the number of the retaining holes 215 may be varied according to the manufacturers' design. For example, the length of the guiding slot 214 is substantially equal to one arc length of the first segment 211a of the rotating disc 211, so that the rotating disc 211 may be rotated by 360 degrees.

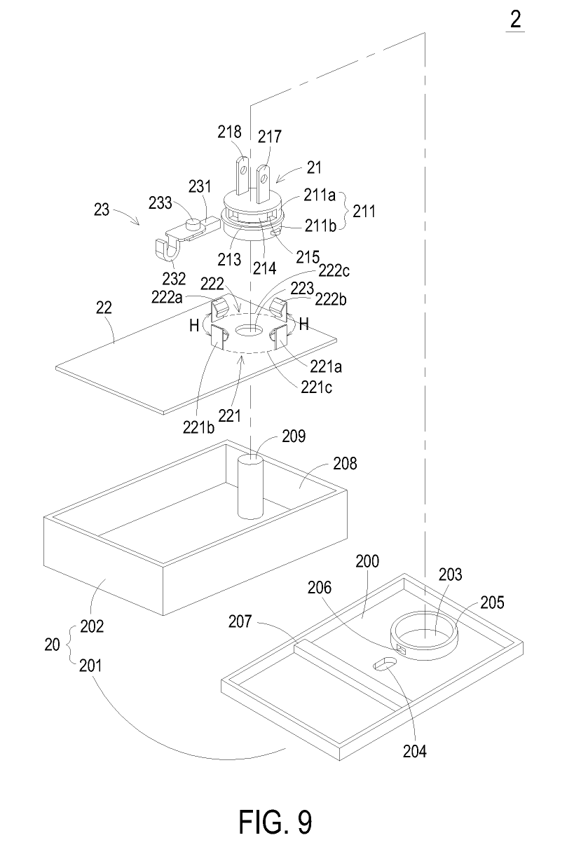

FIG. 9 is a schematic exploded view of an electronic device having a rotatable plug according to a second preferred embodiment of the present invention. The casing 20, the rotary base 21 and the retaining member 23 included in the electronic device 2 of FIG. 9 are identical to those shown in FIG. 3, and are not redundantly described herein.

In the embodiment of FIG. 9, the first conductive element 221 of the circuit board 22 includes a first conductive piece 221a, a second conductive piece 221b and a first trace 221c between the first conductive piece 221a and the second conductive piece 221b. The second conductive element 222 of the circuit board 22 includes a third conductive piece 222a, a fourth conductive piece 222b and a second trace 222c between the third conductive piece 222a and the fourth conductive piece 222b. The first conductive piece 221a, the second conductive piece 221b, the third conductive piece 222a and the fourth conductive piece 222b are discretely arranged at regular intervals. In other words, every two adjacent ones of the first conductive piece 221a, the second conductive piece 221b, the third conductive piece 222a and the fourth conductive piece 222b are discretely arranged at 90 degrees with respect to the centerline of the perforation 223. Under this circumstance, the first conductive piece 221a and the second conductive piece 221b of the first conductive element 221 are respectively opposed to the third conductive piece 222a and the fourth conductive piece 222b.

Since every two adjacent retaining holes 215 are discretely arranged in the guiding slot 214 at 90 degrees with respect to the centerline of the rotating disc 211, the rotary base 21 may be fixed at a specified position when the alignment post 231 is inserted into one of the retaining holes 215. In a case that the second end 217b of the first conducting pin 217 is contacted with the first conductive piece 221a or the second conductive piece 221b of the first conductive element 221, the second end 218b of the second conducting pin 218 is contacted with the third conductive piece 222a or the fourth conductive piece 222b of the second conductive element 222. Whereas, in a case that the second end 217b of the first conducting pin 217 is contacted with the third conductive piece 222a or the fourth conductive piece 222b of the second conductive element 222, the second end 218b of the second conducting pin 218 is contacted with the first conductive piece 221a or the second conductive piece 221b of the first conductive element 221. Therefore, the conducting pins 217 and 218 are always electrically connected to the circuit board 22 if the rotary base 21 is fixed at the specified position. The operations of the electronic device of this embodiment are identical to those illustrated in FIGS. 6˜8, and are not redundantly described herein.

From the above embodiments, the plug of the electronic device of the present invention is rotatable and fixed at a specified position. Even if the power socket is located at the wall corner or other articles are disposed in the vicinity of the power socket, the plug may be rotated to comply with the power socket. Moreover, the rotatable plug is easily assembled and securely fixed in the specified position. The conducting pins of the rotatable plug are always electrically connected to the circuit board when the rotatable plug is fixed at the specified position.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An electronic device having a rotatable plug, said electronic device comprising:
a casing having a hollow portion;
a rotary base rotatably mounted within said casing and comprising a rotating disc and a plug, said plug comprising a first conducting pin and a second conducting pin, wherein said first and second conducting pins are coupled with said rotating disc such that respective first ends of said first and second conducting pins are exposed and protruded through said hollow portion of said casing and respective second ends of said first and second conducting pins are protruded from bilateral sides of said rotating disc; and
a circuit board mounted within said casing and comprising a first conductive element and a second conductive element corresponding to said first and second conducting pins, wherein said first conducting pin and said second conducting pin are respectively contacted with said first conductive element and said second conductive element when said rotary base is rotated to a first position, and said first conducting pin and said second conducting pin are respectively contacted with said second conductive element and said first conductive element when said rotary base is rotated to a second position.

2. The electronic device according to claim 1 wherein said casing comprises a first case element and a second case element.

3. The electronic device according to claim 2 wherein a perforation is formed in said first case element and in the vicinity of said hollow portion, and said hollow portion and said perforation are both extended from an internal surface to an external surface of said first case element.

4. The electronic device according to claim 3 wherein an annular frame is formed on said inner surface of said first case element and around a periphery of said hollow portion such that said rotary base is partially received in said hollow portion and enclosed by said annular frame.

5. The electronic device according to claim 4 wherein a sustaining element is formed on said internal surface of said first case element and extended between bilateral edges of said first case element.

6. The electronic device according to claim 5 wherein said plug and said rotating disc are integrally formed as said rotary base.

7. The electronic device according to claim 6 wherein said plug further comprises a rotating shaft, and said first conducting pin and said second conducting pin are coupled with said rotating shaft by a plastic molding process.

8. The electronic device according to claim 6 wherein said rotating disc further comprises a stopper on a sidewall thereof, wherein said stopper is sustained against said annular frame when said rotating disc is partially received in said hollow portion.

9. The electronic device according to claim 8 wherein said rotating disc further comprises a guiding slot on a sidewall thereof.

10. The electronic device according to claim 9 wherein said rotating disc further comprises a plurality of retaining holes, which are discretely arranged in said guiding slot at regular intervals.

11. The electronic device according to claim 9 wherein said rotating disc comprises three retaining holes, which are discretely arranged in said guiding slot at 90 degrees with respect to the centerline of said rotating disc.

12. The electronic device according to claim 11 further comprising a retaining member, which is interconnected between said sustaining element of said first case element and said rotating disc, for fixing said rotating disc.

13. The electronic device according to claim 12 wherein said retaining member comprises:
an alignment post inserted into one of said retaining holes of said rotating disc such that said rotating disc is fixed at a specified position;
a resilient element having one terminal contacted with said alignment post and the other terminal contacted with said sustaining element of said first case element for providing a restoring force to facilitate automatically inserting said alignment post into said one of said retaining holes; and
a protrusion disposed on said resilient element and received in said perforation of said first case element, wherein said alignment post is gradually detached from said retaining hole and said protrusion is moved toward the sustaining element to compress said resilient element during a process of rotating said rotating disc from one position to another position.

14. The electronic device according to claim 13 wherein said alignment post, said resilient element and said protrusion of said retaining member are integrally formed.

15. The electronic device according to claim 2 wherein a retaining post is extended from an internal surface of said second case element.

16. The electronic device according to claim 15 wherein said rotating disc further comprises an indentation corresponding to said retaining post and said circuit board further comprises a perforation corresponding to said indentation of the rotating disc and said retaining post of said second case element, wherein said retaining post is penetrated through said perforation of said circuit board and partially received in said indentation of said rotating disc such that said circuit board and said rotary base are positioned within said casing by said retaining post.

17. The electronic device according to claim 1 wherein said first and second conductive elements are arc-shaped conductive plates.

18. The electronic device according to claim 1 wherein said first conductive element of said circuit board includes a first conductive piece, a second conductive piece and a first trace between said first conductive piece and said second conductive piece, said second conductive element of said circuit board includes a third conductive piece, a fourth conductive piece and a second trace between said third conductive piece and said fourth conductive piece, and said first, second, third and fourth conductive pieces are discretely arranged at regular intervals.

19. The electronic device according to claim 1 wherein said first conductive element and said second conductive element are spaced from each other by a gap, thereby providing a desired creepage distance between said first conducting pin and said second conducting pin.

20. The electronic device according to claim 1 wherein said electronic device is a power converter.
